(19) United States
(12) Patent Application Publication
(10) Pub. No.: US 2025/0236211 A1
(43) Pub. Date: Jul. 24, 2025

(54) EARTHWORK MACHINE

(71) Applicant: KOMATSU LTD., Tokyo (JP)

(72) Inventors: Takuya SATO, Tokyo (JP); Takashi HIROTA, Tokyo (JP); Koji OBATA, Tokyo (JP)

(21) Appl. No.: 18/849,191

(22) PCT Filed: Mar. 17, 2023
(86) PCT No.: PCT/JP2023/010653

§ 371 Date: Sep. 20, 2024

(30) Foreign Application Priority Data
Mar. 25, 2022 (JP) 2022-049821

(51) Int. Cl. B60L 58/33; B60L 50/75; B60P 1/04; H01M 8/04029; H01M 8/24

(52) U.S. Cl. CPC B60L 58/33; B60L 50/75; H01M 8/04029; H01M 8/24; B60L 2200/40; B60P 1/04; H01M 2250/20

(57) ABSTRACT

An earthwork machine includes a vehicle body, a fuel cell, a housing, and a refrigerant pipe. The housing stores the fuel cell and is electrically connected to the vehicle body. The refrigerant pipe penetrates the housing and allows a refrigerant to flow from the outside of the housing to the fuel cell. The refrigerant pipe is electrically insulated from the housing and is configured such that the refrigerant and the vehicle body are electrically connected to each other on the outside of the housing.

### CROSS-REFERENCE TO RELATED APPLICATIONS

This application is a U.S. National stage application of International Application No. PCT/JP2023/010653, filed on Mar. 17, 2023. This U.S. National stage application claims priority under 35 U.S.C. § 119 (a) to Japanese Patent Application No. 2022-049821, filed in Japan on Mar. 25, 2022, the entire contents of which are hereby incorporated herein by reference.

### TECHNICAL FIELD

The present disclosure relates to an earthwork machine.

Priority is claimed to Japanese Patent Application No. 2022-049821, filed Mar. 25, 2022, the content of which is incorporated herein by reference.

### BACKGROUND INFORMATION

In recent years, in order to use clean energy as a power source for an earthwork machine instead of fossil fuels, mounting a fuel cell on the earthwork machine has been studied. Japanese Unexamined Patent Application, First Publication No. 2017-109691 discloses a technology for grounding means of a vehicle equipped with the fuel cell.

### SUMMARY

The fuel cell has a low insulation resistance, whereas a high insulation resistance is required for earthwork machines, such as dump trucks. For example, in ISO 14990-1, ISO 14990-2, and ISO 14990-3, an insulation resistance of 1 MΩ or more is required between an electric power circuit provided in the earthwork machine and an equipotential bonding circuit.

An object of the present disclosure is to provide an earthwork machine capable of achieving a high insulation resistance while mounting a fuel cell thereon.

According to one aspect of the present disclosure, an earthwork machine includes: a vehicle body; a fuel cell; a housing storing the fuel cell and electrically connected to the vehicle body; and a refrigerant pipe penetrating the housing, allowing a refrigerant to flow from the outside of the housing to the fuel cell, electrically insulated from the housing, and configured such that the refrigerant and the vehicle body are electrically connected to each other on the outside of the housing.

According to the above aspect, it is possible to achieve a high insulation resistance while mounting the fuel cell.

### BRIEF DESCRIPTION OF DRAWINGS

FIG. 1 is a perspective view schematically showing a transport vehicle according to a first embodiment.

FIG. 2 is a schematic diagram showing the configuration of a fuel cell unit according to the first embodiment.

FIG. 3 is a schematic block diagram showing the configuration of the electric system of the transport vehicle according to the first embodiment.

### DESCRIPTION OF EMBODIMENTS

### First Embodiment

### <<Configuration of Transport Vehicle 10>>

Hereinafter, embodiments will be described in detail with reference to the drawings.

A transport vehicle 10 according to a first embodiment is a rigid frame-type dump truck that transports a crushed stone material, or the like, mined in a mine, or the like. The transport vehicle 10 is driven by a fuel cell that uses a hydrogen gas as a fuel. The transport vehicle 10 is an example of an earthwork machine.

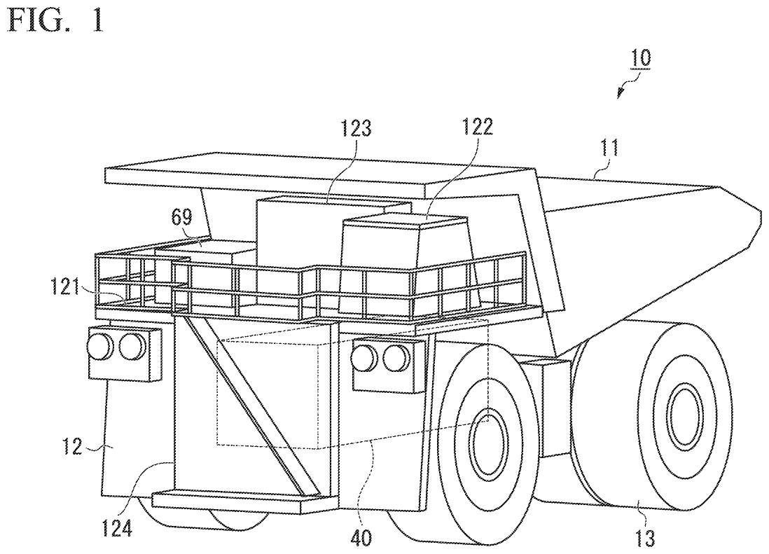

FIG. 1 is a perspective view schematically showing the transport vehicle 10 according to the first embodiment. The transport vehicle 10 includes a dump body 11, a vehicle body 12, and a travel device 13.

The dump body 11 is a member into which a cargo is loaded. At least a part of the dump body 11 is disposed above the vehicle body 12. The dump body 11 performs a dumping operation and a lowering operation. Through the dumping operation and the lowering operation, the dump body 11 is adjusted to have a dumping posture and a loading posture. The dumping posture refers to a posture in which the dump body 11 is raised. The loading posture refers to a posture in which the dump body 11 is lowered.

The dumping operation refers to an operation of separating the dump body 11 from the vehicle body 12 and inclining the dump body 11 in a dumping direction. The dumping direction is a rearward direction of the vehicle body 12. In the embodiment, the dumping operation includes raising a front end part of the dump body 11 and inclining the dump body 11 rearward. Through the dumping operation, a loading surface of the dump body 11 is inclined rearward and downward.

The lowering operation refers to an operation of bringing the dump body 11 closer to the vehicle body 12. In the embodiment, the lowering operation includes lowering the front end part of the dump body 11.

When carrying out dumping work, the dump body 11 performs the dumping operation to change from the loading posture to the dumping posture. In a case where the cargo is loaded into the dump body 11, the cargo is discharged rearward from a rear end part of the dump body 11 through the dumping operation. When carrying out loading work, the dump body 11 is adjusted to have the loading posture.

The vehicle body 12 includes a vehicle body frame (not shown). The vehicle body frame constitutes a protective equipotential bonding circuit of the transport vehicle 10. The vehicle body 12 rotatably supports the dump body 11 through a hinge pin provided on the vehicle body frame. The vehicle body 12 is supported by the travel device 13. A platform 121 is provided at the vehicle body frame above front wheels of the travel device 13. The platform 121 is a flat plate constituting an upper surface of the vehicle body frame. A cab 122, a control cabinet 123, and a retarder grid 69 are provided on the platform 121. In addition, a fuel cell system 40 is provided on the vehicle body frame. An opening in which a grille 124 is fitted is provided on the front surface of the vehicle body 12.

The control cabinet 123 converts electric power. Specifically, the control cabinet 123 performs electric power control between the fuel cell system 40, various electric devices (i.e., a battery 62, a traveling motor 65, a hydraulic pump motor 67, or the like), and the retarder grid 69.

The retarder grid 69 is a resistor for absorbing regenerative electric power generated by braking of the travel device 13. The retarder grid 69 converts the regenerative electric power into heat energy.

The travel device 13 supports the vehicle body 12. The travel device 13 causes the transport vehicle 10 to travel. The travel device 13 causes the transport vehicle 10 to advance or retreat. At least a part of the travel device 13 is disposed below the vehicle body 12. The travel device 13 includes a pair of front wheels and a pair of rear wheels. The front wheels are steering wheels, and the rear wheels are driving wheels.

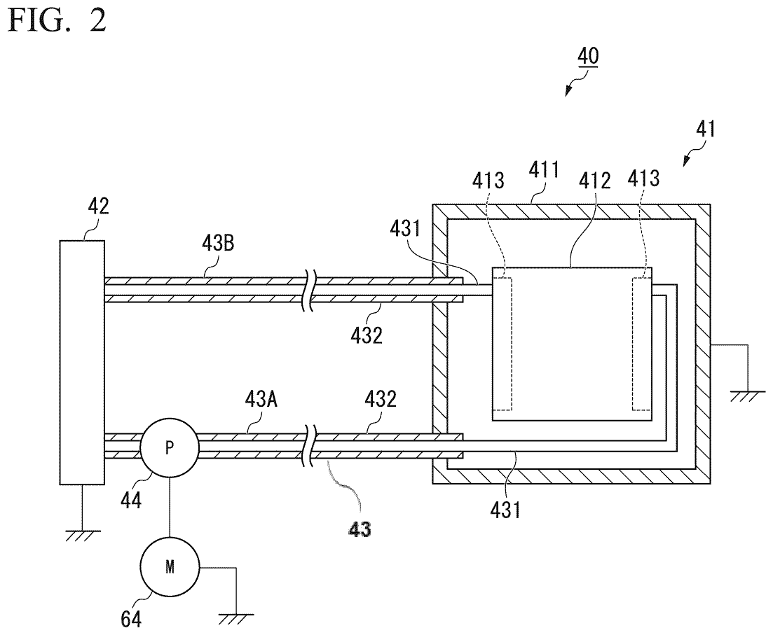

FIG. 2 is a schematic diagram showing the configuration of a fuel cell unit 41 according to the first embodiment.

The fuel cell system 40 includes a plurality of fuel cell units 41. As shown in FIG. 2, each fuel cell unit 41 includes a housing 411 and a fuel cell 412. The fuel cell 412 is stored in the housing 411. The fuel cell 412 generates electricity by performing an electrochemical reaction between hydrogen supplied from a hydrogen tank (not shown) and oxygen contained in the outside air. The fuel cell 412 is provided with a cooling water channel 413 that is a flow channel through which cooling water flows, and the cooling water channel 413 is configured to enable temperature management of the fuel cell 412. The housing 411 is made of metal. The housing 411 and the fuel cell 412 are electrically insulated from each other. For example, a spacer made of an insulator may be provided between the housing 411 and the fuel cell 412. The housing 411 is electrically connected to the vehicle body frame. That is, the housing 411 is frame-grounded.

The fuel cell system 40 includes a plurality of radiators 42 corresponding to the fuel cell units 41. The radiators 42 are arranged side by side behind the grille 124. The radiator 42 cools the cooling water with outside air flowing in through the grille and supplies the cooling water to the corresponding fuel cell unit 41. The radiator 42 is electrically connected to the vehicle body frame. That is, the radiator 42 is frame-grounded. A cooling water pipe 43 (i.e., a first cooling water pipe 43A and a second cooling water pipe 43B) is connected to the radiator 42. One end of the first cooling water pipe 43A is connected to the discharge port of the radiator 42, and the other end thereof is connected to the inflow port of the cooling water channel 413 in the fuel cell 412. One end of the second cooling water pipe 43B is connected to the discharge port of the cooling water channel 413 of the fuel cell 412, and the other end thereof is connected to the inflow port of the radiator 42. A wall surface of the cooling water channel 413 in the fuel cell 412 is made of metal. Therefore, the cooling water passing through the cooling water channel 413 is electrically connected to the output voltage of the fuel cell 412. The cooling water is an example of a refrigerant, and the cooling water pipe 43 is an example of a refrigerant pipe.

The cooling water pipe 43 includes an inner pipe 431 made of an insulator and a shielding part 432 made of metal that covers the inner pipe 431. Therefore, the cooling water passing through the cooling water pipe 43 is electrically insulated from the housing 411. On the other hand, the shielding part 432 of the cooling water pipe 43 is electrically connected to the housing 411. A circulation pump 44 that circulates the cooling water is provided in the first cooling water pipe 43A. The circulation pump 44 is driven by a circulation pump motor 64. The circulation pump motor 64 is electrically connected to the vehicle body frame. That is, the circulation pump motor 64 is frame-grounded. The circulation pump 44 is provided on the outside of the housing 411 and is an example of a refrigerant pump that pressure-feeds the cooling water of the cooling water pipe 43. The length of the first cooling water pipe 43A from the fuel cell 412 to the pump 44 is equal to or greater than a length at which the resistance of the cooling water in the cooling pipe reaches a predetermined insulation resistance (for example, 1 MΩ), and the length from the second cooling water pipe 43B to the radiator 42 is equal to or greater than a length at which the resistance of the cooling water in the cooling pipe reaches a predetermined insulation resistance (for example, 1 MΩ). Here, in a case where a length of the pipe is denoted by L, a resistivity of the cooling water is denoted by p, and a cross-sectional area of the pipe is denoted by S, the resistance of the cooling water can be represented by R=ρ·L/S.

With the above configuration, the fuel cell 412 is connected to the frame-grounded circulation pump motor 64 and the frame-grounded radiator 42 through the cooling water flowing through the cooling water pipe 43. Since the inner pipe 431 of the cooling water pipe 43 is made of an insulator and is configured to have a length such that the resistance of the cooling water is equal to or greater than the insulation resistance, the fuel cell 412 can secure the insulation resistance required for the earthwork machine. Since the cooling water is installed to the frame ground through the insulation resistance, the cooling water has a potential between the output voltage of the fuel cell and the frame ground. However, by providing the metal shielding part 432 on the outside of the cooling water pipe 43, even if water leakage occurs in the cooling water pipe 43, the leaked cooling water comes into contact with the shielding part 432, and thus the cooling water is frame-grounded through the circulation pump motor 64 or the radiator 42.

### <<Configuration of Electric System 60>

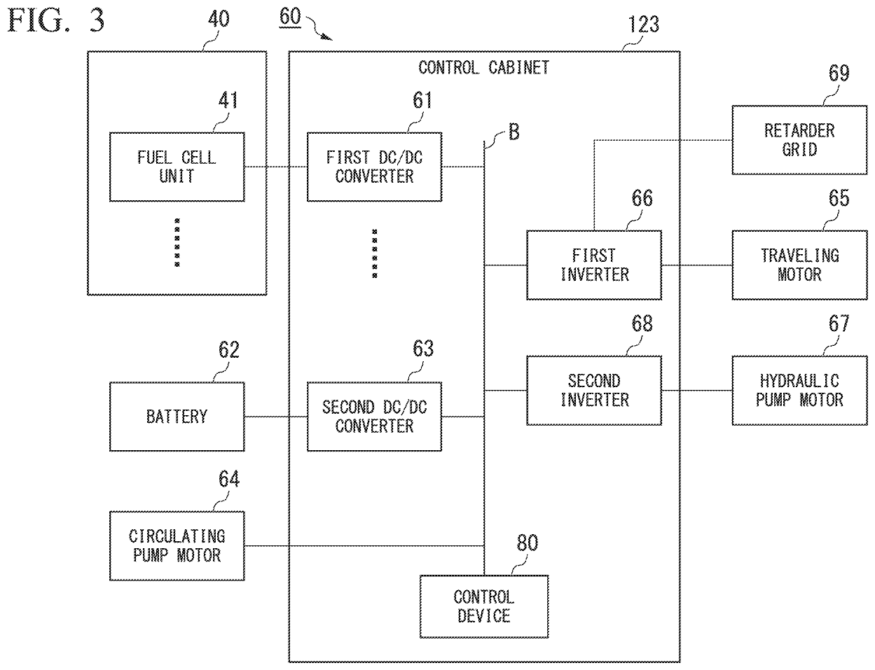

FIG. 3 is a schematic block diagram showing the configuration of an electric system 60 of the transport vehicle 10 according to the first embodiment. The electric system 60 includes the fuel cell unit 41, a first DC/DC converter 61, the battery 62, a second DC/DC converter 63, the circulation pump motor 64, the traveling motor 65, a first inverter 66, the hydraulic pump motor 67, a second inverter 68, the retarder grid 69, and a control device 80. The first DC/DC converter 61, the second DC/DC converter 63, the first inverter 66, the second inverter 68, and the control device 80 are provided inside the control cabinet 123.

The electric system 60 includes the same number of first DC/DC converters 61 as the number of the fuel cell units 41. The first DC/DC converter 61 is connected to the corresponding fuel cell unit 41. The first DC/DC converter 61 supplies the DC power generated by the fuel cell system 40 to a bus B. The first DC/DC converter 61 is an isolated DC/DC converter. That is, the first DC/DC converter 61 includes a transformer, and the primary side (the fuel cell unit 41 side) and the secondary side (the bus B side) thereof are insulated. As a result, even if a plurality of fuel cell units 41 are provided in parallel, the required insulation resistance of the entire electric system 60 can be secured as long as each fuel cell unit 41 secures a required insulation resistance therefor.

The battery 62 stores the electric power generated by the fuel cell system 40. The battery 62 may store the regenerative electric power generated by the traveling motor 65. The battery 62 outputs the stored electric power. The second DC/DC converter 63 supplies electric power charged in the battery 62 to the bus B. In addition, the second DC/DC converter 63 charges the battery 62 by adjusting a voltage of DC power flowing in the bus B and supplying the adjusted voltage to the battery 62. That is, the second DC/DC converter 63 is an example of a DC/DC converter that can perform bidirectional electric power conversion. The battery 62 includes a battery management system (BMS) (not shown) that monitors the state of the battery 62. The BMS measures the charging rate of the battery 62 and outputs the measurement data to the control device 80.

The circulation pump motor 64 drives the circulation pump 44 shown in FIG. 2 using the DC power flowing in the bus B.

The traveling motor 65 is a three-phase AC electric motor that drives the travel device 13. The first inverter 66 converts the DC power flowing in the bus B into three-phase AC power and supplies the three-phase AC power to the traveling motor 65. In addition, the first inverter 66 converts the regenerative electric power generated by the traveling motor 65 into DC current and causes the retarder grid 69 to consume it.

The hydraulic pump motor 67 is a three-phase AC electric motor that drives a hydraulic pump (not shown) for driving the dump body 11. The second inverter 68 converts the DC power flowing in the bus B into three-phase AC power and supplies the three-phase AC power to the hydraulic pump motor 67.

The control device 80 controls the first DC/DC converter 61, the second DC/DC converter 63, the first inverter 66, and the second inverter 68.

As described above, the transport vehicle 10 according to the first embodiment includes the following configurations. The transport vehicle 10 includes the housing 411 electrically connected to the vehicle body 12 and storing the fuel cell 412, and the cooling water pipe 43 penetrating the housing 411 and allowing a refrigerant to flow from the outside of the housing 411 to the fuel cell 412. The cooling water pipe 43 according to the first embodiment is electrically insulated from the housing 411, and the cooling water passing through the cooling water pipe 43 is electrically connected to the vehicle body 12 on the outside of the housing 411. The fuel cell 412 according to the first embodiment is electrically insulated from the housing 411, and thus can be prevented from being electrically connected to the vehicle body 12 through the housing 411 with low resistance. In addition, although electricity flows through the cooling water passing through the cooling water pipe 43, since the cooling water is insulated from the housing 411 and is electrically connected to the vehicle body 12 on the outside of the housing 411, a resistance corresponding to the distance from the fuel cell 412 to the frame-grounded point can be obtained. As a result, the transport vehicle 10 can achieve a high insulation resistance while mounting the fuel cell 412 thereon.

In addition, the circulation pump motor 64 according to the first embodiment is frame-grounded, and thus the electricity flowing through the cooling water passing through the cooling water pipe 43 is frame-grounded through the circulation pump motor 64. It should be noted that, in the transport vehicle 10 according to another embodiment, the electricity may not be frame-grounded through the circulation pump motor 64, and may be frame-grounded through, for example, the circulation pump 44, or may be frame-grounded by another configuration, such as bringing a frame-grounded brush (not shown) into contact with the shaft of the motor 64. Further, since the radiator 42 according to the first embodiment is frame-grounded, the electricity flowing through the cooling water is not only frame-grounded through the circulation pump motor 64 but is also frame-grounded through the radiator 42. On the other hand, the radiator 42 can also be set to a floating potential without being frame-grounded. In this case, since the radiator 42 has a potential, the radiator 42 is covered with the grille 124 and a housing such that a person cannot easily access the radiator 42. In addition, the circulation pump motor 64 or the circulation pump 44 can also be set to a floating potential. In this case, since the circulation pump motor 64 or the circulation pump 44 has a potential, the circulation pump motor 64 or the circulation pump 44 is covered with a housing (not shown) such that a person cannot easily access the circulation pump motor 64 or the circulation pump 44.

In addition, in the transport vehicle 10 according to the first embodiment, the length of the first cooling water pipe 43A of the cooling water pipe 43 from the fuel cell 412 to the pump 44 and the length from the second cooling water pipe 43B of the cooling water pipe 43 to the radiator 42 are each equal to or greater than the length at which the resistance of the cooling water passing through the cooling water pipe 43 reaches a predetermined insulation resistance. As a result, the transport vehicle 10 can achieve the desired insulation resistance. It should be noted that, by ensuring the insulation resistance with the length of the portion that is exposed to the outside of the housing 411, the length of the pipe inside the housing 411 can be shortened, and the size of the housing 411 itself can be reduced. In addition, although the distances between the plurality of fuel cell units 41 and the corresponding radiators 42, which are provided in the transport vehicle 10 according to the first embodiment, are different from each other, the insulation resistances of the fuel cell units 41 can be made to be equivalent by making the lengths of the portions of the cooling water pipes 43 that are exposed to the outsides of the housings 411 be equivalent.

In addition, the cooling water pipe 43 according to the first embodiment includes the inner pipe 431 made of an insulator and the shielding part 432 made of metal that covers the inner pipe 431. As a result, even if water leakage occurs in the cooling water pipe 43, the cooling water can be frame-grounded by coming into contact with the shielding part 432.

In addition, the transport vehicle 10 according to the first embodiment is connected to the first DC/DC converter 61, which is an isolated DC/DC converter, corresponding to each of the plurality of fuel cell units 41. As a result, as long as the required insulation resistance can be secured in each of the fuel cell units 41, the required insulation resistance can be secured in the entire electric system 60. For example, as a comparative example, in a case where the first DC/DC converter 61 is a non-isolated DC/DC converter, since the fuel cell units 41 are connected in parallel, the insulation resistance that needs to be ensured by each of the fuel cell units 41 is required to be parallel number times the insulation resistance required by the earthwork machine. Therefore, in the transport vehicle 10 according to the first embodiment, the insulation resistance that needs to be ensured for each of the fuel cell units 41 can be reduced. It should be noted that, in a case where the non-isolated DC/DC converter is adopted as the first DC/DC converter 61, the length of the cooling water pipe 43 may be set to a length at which a resistance value that is parallel number times the insulation resistance required for one fuel cell unit 41 can be obtained, and thus the required insulation resistance may be secured in the entire electric system 60.

Although the embodiments have been described in detail with reference to the drawings, a specific configuration is not limited to the above-described configuration, and various design changes and the like can be made.

The fuel cell system 40 according to the above-described embodiment includes the plurality of radiators 42 corresponding to the plurality of fuel cell units 41, but the present disclosure is not limited to this. For example, the fuel cell system 40 may include a single radiator 42. In this case, the cooling water cooled by the radiator 42 may be branched to the fuel cell units 41, for example, through a manifold. A circulation pump 44 is provided for each fuel cell unit 41 at the latter stage of the manifold. In addition, according to another embodiment, the cooling water cooled by the radiator 42 may be supplied to a plurality of fuel cell units 41 by a single circulation pump 44. In this case, the cooling water pipe 43 branches at the latter stage of the circulation pump 44 and is connected in parallel to the fuel cell units 41.

According to the above-described aspect, it is possible to achieve a high insulation resistance while mounting the fuel cell.

1. An earthwork machine, comprising:
a vehicle body;
a fuel cell;
a housing storing the fuel cell and electrically connected to the vehicle body; and
a refrigerant pipe penetrating the housing, allowing a refrigerant to flow from an outside of the housing to the fuel cell, electrically insulated from the housing, and configured such that the refrigerant and the vehicle body are electrically connected to each other on the outside of the housing.

2. The earthwork machine according to claim 1, further comprising
a refrigerant pump provided on the outside of the housing and configured to pressure-feed the refrigerant of the refrigerant pipe; and
a pump motor configured to drive the refrigerant pump,
the pump motor being electrically connected to the vehicle body.

3. The earthwork machine according to claim 1, wherein
a length of a portion of the refrigerant pipe that is exposed to the outside of the housing is equal to or greater than a length at which a resistance of the refrigerant passing through the refrigerant pipe reaches a predetermined insulation resistance.

4. The earthwork machine according to claim 1, wherein
the refrigerant pipe includes an inner pipe made of an insulator and a shielding part made of metal covering the inner pipe.

5. The earthwork machine according to claim 1, further comprising
a plurality of fuel cells including the fuel cell; and
a plurality of isolated DC/DC converters having primary sides connected to the plurality of fuel cells and secondary sides connected in parallel to each other.

6. The earthwork machine according to claim 2, wherein
a length of a portion of the refrigerant pipe that is exposed to the outside of the housing is equal to or greater than a length at which a resistance of the refrigerant passing through the refrigerant pipe reaches a predetermined insulation resistance.

7. The earthwork machine according to claim 2, wherein
the refrigerant pipe includes an inner pipe made of an insulator and a shielding part made of metal covering the inner pipe.

8. The earthwork machine according to claim 3, wherein
the refrigerant pipe includes an inner pipe made of an insulator and a shielding part made of metal covering the inner pipe.

9. The earthwork machine according to claim 6, wherein
the refrigerant pipe includes an inner pipe made of an insulator and a shielding part made of metal covering the inner pipe.

10. The earthwork machine according to claim 2, further comprising
a plurality of fuel cells including the fuel cell; and
a plurality of isolated DC/DC converters having primary sides connected to the plurality of fuel cells and secondary sides connected in parallel to each other.

11. The earthwork machine according to claim 3, further comprising
a plurality of fuel cells including the fuel cell; and
a plurality of isolated DC/DC converters having primary sides connected to the plurality of fuel cells and secondary sides connected in parallel to each other.

12. The earthwork machine according to claim 4, further comprising
a plurality of fuel cells including the fuel cell; and
a plurality of isolated DC/DC converters having primary sides connected to the plurality of fuel cells and secondary sides connected in parallel to each other.

13. The earthwork machine according to claim 6, further comprising
a plurality of fuel cells including the fuel cell; and
a plurality of isolated DC/DC converters having primary sides connected to the plurality of fuel cells and secondary sides connected in parallel to each other.
